(19) United States
(12) Patent Application Publication
(10) Pub. No.: US 2024/0408638 A1
(43) Pub. Date: Dec. 12, 2024

(54) LIQUID DEVICE

(71) Applicant: BHS Corrugated Maschinen- und Anlagenbau GmbH, Weiherhammer (DE)

(72) Inventor: Thomas HECKY, Weiden (DE)

(21) Appl. No.: 18/719,011

(22) PCT Filed: Dec. 9, 2022
(86) PCT No.: PCT/EP2022/085144

§ 371 Date: Jun. 12, 2024

(30) Foreign Application Priority Data
Dec. 21, 2021 (DE) 10 2021 214 832.8

(51) Int. Cl. B05C 1/10; B05C 1/08; B31F 1/28

(52) U.S. Cl. CPC B05C 1/10; B05C 1/0808; B31F 1/2818

(57) ABSTRACT

The invention relates to a liquid device comprising a main part (72), an intermediate body (75) which is arranged above the main part (72), and an opening body (78) which is arranged above the intermediate body (75) and which has openings (79). The intermediate body (75) and/or the opening body (78) can be acted upon and the intermediate body (75) is designed such that the intermediate body (75) is capable of changing a liquid-receiving volume of at least one opening (79), in particular of a plurality of openings (79), by at least partly engaging in the same.

The invention pertains to a liquid device. Furthermore, the invention is aimed at a liquid apparatus comprising at least one such liquid device and to a system comprising at least one such liquid apparatus.

As is well known, it is often the case that metering devices, application devices, transfer devices or the like have to be replaced in their entirety or in parts thereof in order to meet corresponding, such as new or changed, requirements. This often means that production has to be interrupted.

The invention is based on the object of providing a liquid device which can be easily and reliably adapted to different (production) requirements, demands or jobs and is thus particularly versatile. The liquid device should also make a particularly efficient and sustainable production possible. A corresponding liquid apparatus and a corresponding system are also to be provided.

This object is achieved according to the invention by the features specified in the main claims 1, 12 and 14. The core of the invention lies in the opening body and intermediate body, which is capable of at least partly engaging in at least one opening of the openings and thus changing their, in particular free, respective liquid-receiving volume or liquid-dispensing volume correspondingly. Preferably, such a surface structure of the liquid device can be changed at least in regions, in particular reversibly.

The opening body and intermediate body are capable of interacting with each other correspondingly. They are preferably capable of carrying out a relative movement in relation to one another, at least in regions, when the intermediate body engages in the opening body. It is expedient if the opening body offers mechanical resistance to the relative movement and/or to the engagement of the intermediate body in the opening body, at least in regions.

For example, the intermediate body and/or the opening body can be acted upon correspondingly, such as at least partly displaced, subjected to a force such as tensile force or compressive force, or the like. The intermediate body can, for example, be acted on to such an extent that it changes its volume and/or shape at least in regions. It is preferably flexible, yielding, inflatable or the like.

It is expedient if the liquid-receiving volume of the at least one opening can be changed purposefully, for example stepwise or continuously. It is advantageous if the at least one opening is closed on one side by the intermediate body, in particular always, preferably tightly, and on an opposite side facing away from the intermediate body is preferably always open, in particular forming a liquid inlet or liquid outlet. The intermediate body preferably forms a liquid barrier. It is advantageously able to fill the at least one opening at least partly or in regions, for example even completely. The intermediate body then preferably lies in the respective opening or adjacent to it, close to the opening body. It is expedient if the intermediate body is also able to remain disengaged from the opening body and thus leaving the liquid-receiving volume unaffected.

It is advantageous if liquid is able to enter the opening body from the side facing away from the intermediate body, provided that the intermediate body allows this. The opening body is then able to receive liquid into its openings via their liquid inlets. From there, the liquid can also be released in the opposite direction, for example to a medium such as a web or a sheet, and/or a counterbody such as a roller. The liquid inlets then also form liquid outlets.

The intermediate body is made, for example, of an elastomer or rubber material. It can be in one piece. Alternatively, it is formed from several intermediate elements which are, for example, (substantially) structurally identical.

The main part is preferably rigid or inflexible. For example, it is made in one piece. Alternatively, it is formed from several basic elements which are, for example, (substantially) structurally identical.

For example, the intermediate body is arranged at least in regions directly above the main part or at a distance above it. For example, the intermediate body is arranged accordingly above the main part. For example, the intermediate body surrounds or runs around the main part, at least in regions, preferably completely.

The opening body, for example, is made in one piece. Alternatively, it is formed from several opening elements which are, for example, (substantially) structurally identical. It is useful if the opening body is rigid or inflexible.

Conveniently, the openings are identical. For example, they are arranged regularly, such as in rows and/or columns, or irregularly, at least in regions. They are preferably arranged spatially limited or spaced apart from one another on the circumference. Advantageously, the openings each have a (substantially) constant cross-section. It is expedient if the openings extend in a straight line. The openings can be rounded or chamfered at the ends or have a different cross-section there. It is expedient if each opening has a height or depth of between 1 mm and 50 mm, preferably between 5 mm and 40 mm. Preferably, each opening has an opening size or, for example, minimum or maximum transverse dimension, which is between 0.1 mm and 10 mm, preferably between 0.5 mm and 5 mm.

For example, the opening body is arranged, at least in regions, directly above the intermediate body. For example, the opening body is arranged accordingly above the intermediate body. For example, the opening body surrounds or runs around the intermediate body, at least in regions, preferably completely. The opening body preferably forms a free working surface which faces away from the intermediate body.

The liquid device has, for example, a center plane, center axis or the like, which is preferably oriented perpendicularly or obliquely to the medium and/or its conveying direction, if conveyed, longitudinal direction or the like.

The at least one liquid device and the loading device are, for example, at least temporarily operatively connected to one another, such as in fluidic connection, flow connection or mechanical connection. During operation, the at least one loading device is in particular capable of exerting a compressive force and/or tensile force on the intermediate body and/or opening body or of displacing them relative to one another, at least in regions.

The liquid apparatus is designed, for example, as an apparatus for producing a corrugated board web laminated on one side, as a gluing unit, printing device and/or pre-coating device.

Further advantageous embodiments of the invention are specified in the dependent claims.

According to dependent claim 2, the liquid device is designed as a liquid metering device, liquid squeezing device, liquid application device, liquid transfer device, gluing device, pre-coating device and/or inking device. It or its working surface is, for example, capable of metering, squeezing, applying and/or transferring a liquid. The liquid is, for example, glue, a pre-coating (primer) or ink, especially printing ink.

The openings according to dependent claim 3 preferably form a connection between the intermediate body and the surrounding environment.

According to dependent claim 4, the openings are arranged in a large part of the opening body, in particular in a large part of an effective liquid region or surface region thereof. Such a liquid device can be used in a wide variety of ways.

In the liquid device according to dependent claim 5, the openings are preferably laterally delimited or separated from one another by separating elements, in particular thin webs, walls or the like, which preferably forms the working surface of the opening body. The working surface or surface of the opening body is preferably grid-like or screen-like.

The embodiment according to dependent claim 6 allows a particularly advantageous orientation of the openings in relation to one another. Each opening is preferably designed as a polygon, such as a rectangle. In particular, each opening takes the form of a regular polygon. It preferably has a corresponding cross-section. The openings are, for example, oriented such that a center plane, center axis or diagonal thereof runs perpendicular, obliquely or parallel to a center plane or center axis of the liquid device and/or longitudinal direction and/or conveying direction, if conveyed, of the medium. Alternatively, the openings in plan view or in cross-section are, for example, circular, oval or the like. Combinations of shapes are possible.

The design according to dependent claim 7 allows a particularly major change in the liquid that can be received in the opening body and preferably also dispensed. The more the intermediate body reduces the liquid-receiving volume, the less liquid can be received and dispensed again.

According to dependent claim 8, the intermediate body and/or opening body can be acted upon, for example, in only at least one partial region, such as, for example, the central or outer width region, which allows targeted loading. This makes particularly reliable and efficient production possible. Preferably, the effective working surface can be adjusted in this way. For example, the liquid device is therefore able to receive or apply locally different amounts of liquid. For example, the humidity in the medium that is in operative connection or interaction with the liquid device or receives liquid from it can also be compensated for or influenced. Alternatively, for example, a different application of ink is possible.

The embodiment according to dependent claim 9 allows a particularly efficient production. The roller is designed, for example, as a solid roller or a hollow roller. It is advantageously mounted so that it can rotate or be driven in rotation. The main part, intermediate body and opening body preferably have a common longitudinal center axis. This preferably extends horizontally during use. It is expedient if the opening body has a fixed, in particular unchangeable, distance from the longitudinal center axis.

The liquid device according to dependent claim 10 is particularly functionally reliable. It is expedient if the at least one loading duct has at least one outlet which is arranged adjacent to the intermediate body or faces it. It conveniently opens out into the intermediate body. Preferably, several loading ducts are present.

The main part according to dependent claim 11 is, for example, rectangular in shape. It is useful if the height can be adjusted, especially in a targeted manner. Advantageously, the intermediate body is arranged, for example, directly above the main part. The opening body, for example, is arranged in a fixed position. The intermediate body is in particular capable of engaging in the opening body, preferably from below.

According to dependent claim 13, the at least one loading device is of a hydraulic, pneumatic and/or mechanical nature. It comprises, for example, a pump, a compressor, a drive or the like. For example, the at least one loading device also has a piston-cylinder unit.

A preferred embodiment of the invention is described below by way of example with reference to the accompanying drawings. The drawings show:

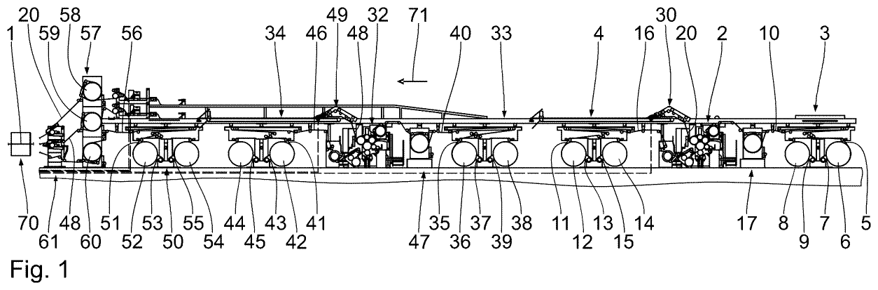

FIG. 1 a partial view of a system according to the invention,

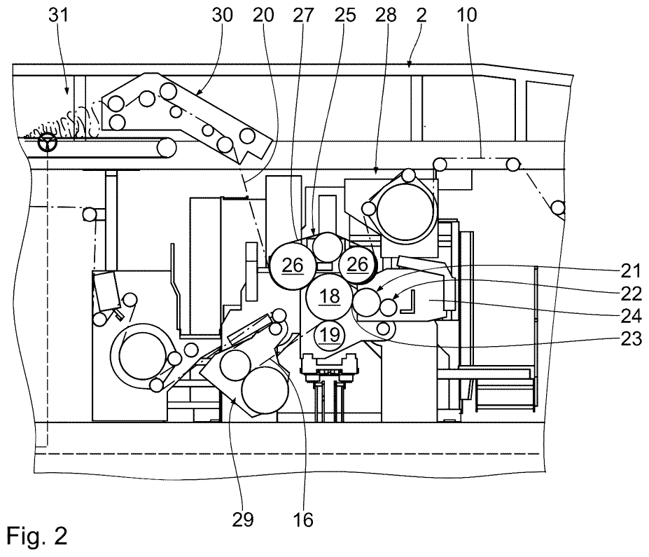

FIG. 2 an apparatus according to the invention for producing a corrugated board web, laminated on one side, of the system shown in FIG. 1,

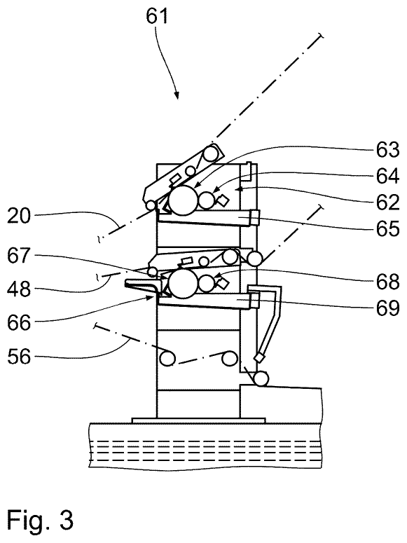

FIG. 3 a gluing unit according to the invention of the system illustrated in FIG. 1,

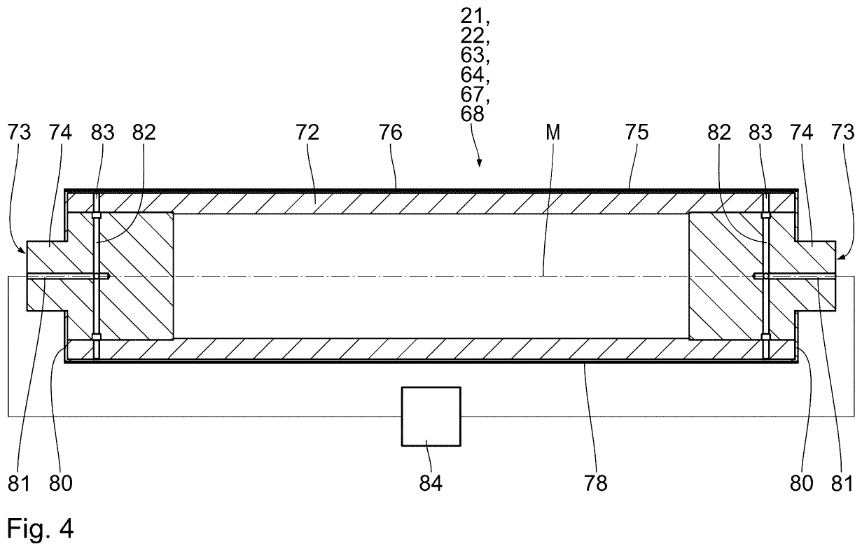

FIG. 4 a liquid apparatus according to the invention, which can be used, for example, in the apparatus for producing a corrugated board web, laminated on one side, according to FIG. 2 and/or in the gluing unit according to FIG. 3,

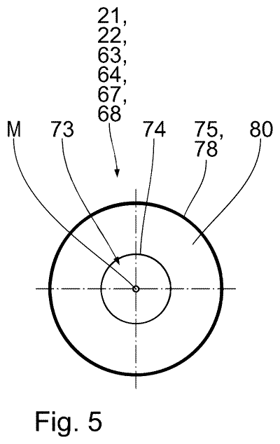

FIG. 5 a cross-section through a liquid device of the liquid apparatus according to FIG. 4,

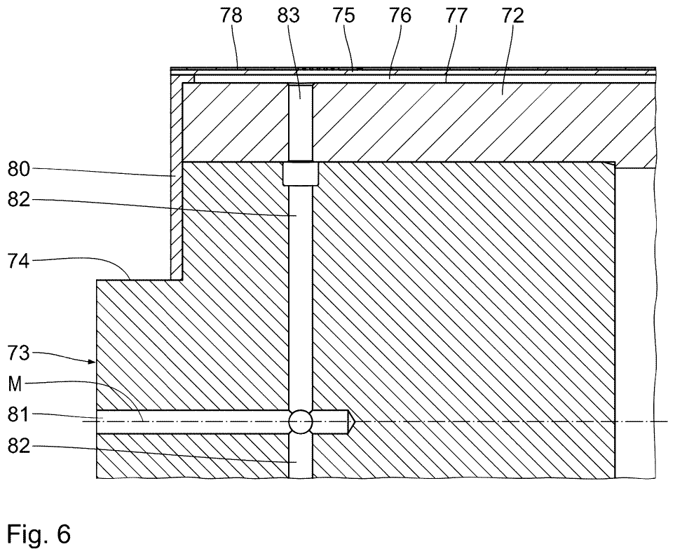

FIG. 6 an end detail of the liquid device of the liquid apparatus illustrated in FIG. 4 and FIG. 5,

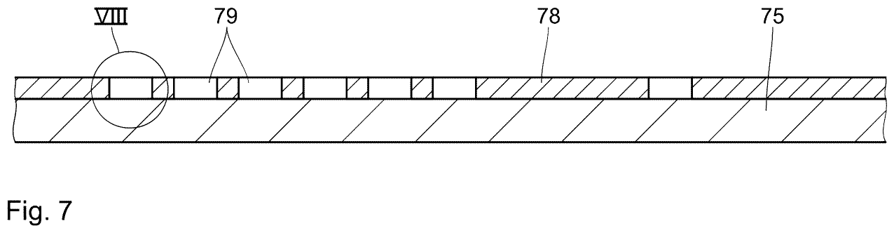

FIG. 7 an outer edge region of the illustrated liquid device, and

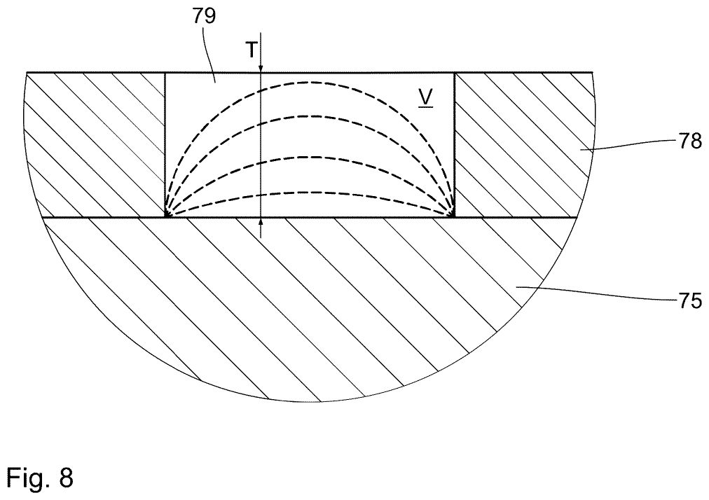

FIG. 8 the detail marked in FIG. 7 on an enlarged scale.

A system partly shown in FIG. 1 comprises a corrugated board unit which is capable of producing an endless corrugated board web 1 which is laminated on both sides or two sides.

The corrugated board unit comprises a first apparatus 2 for producing a first corrugated board web laminated on one side.

A first cover web splicing device 3 and a first material web splicing device 4 are arranged upstream of the first apparatus 2 for producing a first corrugated board web laminated on one side.

The first cover web splicing device 3 comprises a first unrolling unit 7 for unrolling an endless first cover web 5 from a first cover web roll 6 and a second unrolling unit 9 for unrolling an endless second cover web from a second cover web roll 8. The endless first cover web 5 and the endless second cover web are connected to one another in the first cover web splicing device 3 to provide an endless first cover web 10.

The first material web splicing device 4 is designed corresponding to the first cover web splicing device 3. It comprises a third unrolling unit 13 for unrolling an endless first material web 11 from a first material web roll 12 and a fourth unrolling unit 15 for unrolling an endless second material web from a second material web roll 14. The endless first material web 11 and the endless second material web are connected to one another in the first material web splicing device 4 to provide an endless first material web 16.

The endless first cover web 10 is fed via a first heating device 17 to the first apparatus 2 for producing a first corrugated board web laminated on one side. The endless first material web 16 is also fed to the first apparatus 2 for producing a first corrugated board web laminated on one side.

The first apparatus 2 for producing a first corrugated board web laminated on one side comprises a rotatably mounted first corrugating roller 18 and a rotatably mounted second corrugating roller 19 for producing, from the endless first material web 16, an endless first corrugated web having a corrugation (see also FIG. 2). The corrugating rollers 18, 19 form a first roller gap for guiding through and corrugating the endless first material web 16.

In order to connect the endless first cover web 10 to the endless first corrugated web 16 in order to form a first corrugated board web laminated on one side 20, the first apparatus 2 for producing a first corrugated board web laminated on one side has a first glue application device 21 and a first glue metering device 22 associated therewith. For guiding through and gluing the endless first corrugated web 16, the first glue application device 21 forms a first glue gap 23 with the first corrugating roller 18.

Glue located in a first glue container 24 is applied to the peaks of a corrugation of the endless first corrugated web 16 via the first glue application device 21. The first glue application device 21 is arranged between the first corrugating roller 18 and the first glue metering device 22. The first glue metering device 22 serves to form a uniform glue layer on the first glue application device 21.

The endless first cover web 10 is then joined to the endless first corrugated web 16 provided with glue from the first glue container 24 in the first apparatus 2 for producing a first corrugated board web laminated on one side.

In order to press the endless first cover web 10 against the glued endless first corrugated web 16, which in turn rests in regions against the first corrugating roller 18, the first apparatus 2 for producing a first corrugated board web laminated on one side has a first pressing module 25. The first pressing module 25 is advantageously designed as a pressing belt module. It is arranged above the first corrugating roller 18. The first pressing module 25 has two first deflection rollers 26 and a first pressing belt 27 which is guided around the two first deflection rollers 26.

The first corrugating roller 18 engages partly from below into a space between the two first deflection rollers 26, whereby the first pressing belt 27 is deflected by the first corrugating roller 18. The first pressing belt 27 presses against the endless first cover web 10, which in turn is pressed against the endless first corrugated web 16 provided with glue and resting against the first corrugating roller 18.

The first apparatus 2 for producing a first corrugated board web laminated on one side comprises a first web-tension influencing device 28 which is arranged upstream of the first pressing module 25 and is associated with the endless first cover web 10.

The first apparatus 2 for producing a first corrugated board web laminated on one side also has a first corrugating-roller changing apparatus 29 which stores a previously inactive pair of corrugating rollers.

For further conveying of the first corrugated board web 20 laminated on one side, it is fed via a first overhead transport device 30 to a bridge 31 of the corrugated board unit.

The corrugated board unit also has a second apparatus 32 for producing a second corrugated board web laminated on one side.

A second cover web splicing device 33 and a second material web splicing device 34 are arranged upstream of the second apparatus 32 for producing a second corrugated board web laminated on one side.

The second cover web splicing device 33 is designed similarly to the first cover web splicing device 3. This comprises a fifth unrolling unit 37 for unrolling an endless third cover web 35 from a third cover web roll 36 and a sixth unrolling unit 39 for unrolling an endless fourth cover web from a fourth cover web roll 38. The endless third cover web 35 and endless fourth cover web are connected to one another in the second cover web splicing device 33 in order to provide an endless second cover web 40.

The second material web splicing device 34 is designed similarly to the first material web splicing device 4. This comprises a seventh unrolling unit 43 for unrolling an endless third material web 41 from a third material web roll 42 and an eighth unrolling unit 45 for unrolling an endless fourth material web from a fourth material web roll 44. The endless third material web 41 and endless fourth material web are connected to one another in the second material web splicing device 34 to provide an endless second material web 46.

The endless second cover web 40 is fed via a second heating device 47 to the second apparatus 32 for producing a second corrugated board web laminated on one side. The endless second material web 46 is also fed to the second apparatus 32 for producing a second corrugated board web laminated on one side.

The second apparatus 32 for producing a second corrugated board web laminated on one side is designed corresponding to the first apparatus 2 for producing a first corrugated board web laminated on one side. Please refer to the previous description. In the second apparatus 32 for producing a second corrugated board web laminated on one side, a second corrugated board web 48 laminated on one side is formed from the endless second cover web 40 and the endless second material web 46.

For further conveyance of the second corrugated board web 48 laminated on one side, it is fed via a second overhead transport device 49 to the bridge 31.

The corrugated board unit also comprises a lamination web splicing device 50, which is designed similarly to the other splicing devices 3, 4, 33, 34. The lamination web splicing device 50 comprises a ninth unrolling unit 53 for unrolling an endless first lamination web 51 from a first lamination web roll 52 and a tenth unrolling unit 55 for unrolling an endless second lamination web from a second lamination web roll 54. The endless first lamination web 51 and the endless second lamination web are joined together in the lamination web splicing device 50 in order to provide an endless lamination web 56.

Downstream of the first apparatus 2 for producing a first corrugated board web laminated on one side, the apparatus 32 for producing a second corrugated board web laminated on one side, and the lamination web splicing device 50, there is arranged a pre-heating device 57, which comprises three pre-heating rollers 58, 59, 60 arranged one above the other. The corrugated board webs 20, 48 laminated on one side and the endless lamination web 56 are fed to the pre-heating device 57 and wrap around the respective pre-heating roller 58, 59 or 60 and thus undergo a pre-heating.

A gluing unit 61 is arranged downstream of the pre-heating device 57. The gluing unit 61 has a first gluing device 62 with a first gluing application device 63 and a first glue squeezing device 64, which is assigned to the first gluing application device 63 in order to form a uniform glue layer on the first gluing application device 63 or to squeeze out excess glue there (see also FIG. 3). The first gluing application device 63 applies glue from a first glue trough 65 to a corrugation or fluting of the first corrugated board web 20 laminated on one side.

The gluing unit 61 also has a second gluing device 66, which is designed similarly to the first gluing device 62 and is arranged below it. The second gluing device 66 comprises a second gluing application device 67 and a second glue squeezing device 68, which is assigned to the second gluing application device 67 in order to form a uniform glue layer on the second gluing application device 67 or to squeeze out excess glue there. The second gluing application device 67 applies glue from a second glue trough 69 to a corrugation or fluting of the second corrugated board web 48 laminated on one side.

Below the second gluing device 66, the endless lamination web 56 is guided through the gluing unit 61.

Downstream of the gluing unit 61, the corrugated board unit has a heating-pressing device 70 (shown only schematically in FIG. 1) which comprises a horizontally extending heating table. Adjacent to the heating table there is an endless pressing belt guided around guide rollers. A pressing gap is formed between the pressing belt and the heating table, through which the glued, corrugated board webs 20, 48 laminated on one side and the endless lamination web 56 are guided to form the endless, corrugated board web 1 laminated on both sides. The endless corrugated board web 1 has a total of five layers.

Downstream of the heating-pressing device 70, the corrugated board facility has a longitudinally slitting/creasing device (not shown) capable of cutting and scoring the endless corrugated board web 1 to form partial corrugated board webs to facilitate subsequent folding.

Downstream of the slitting/creasing device, the corrugated board facility has a switch (not shown) for dividing the produced partial corrugated board webs into different levels.

Downstream of the switch, the corrugated board facility has a transverse-cutting device (not shown) with transverse-cutting devices arranged one above the other in order to cut the partial corrugated board webs right through perpendicular to a corrugated board transport direction 71 in order to produce corrugated board sheets.

Downstream of each transverse-cutting device, a conveyor belt (not shown) is arranged to guide the corrugated board sheets to a respective stacking tray (not shown).

A printing device (not shown) can be integrated into the corrugated board facility in order to obtain a printed endless corrugated board web 1 or corrugated board sheets. Alternatively, the printing device is arranged upstream of the corrugated board facility. A web can be printed on there and then wound up into a web roll, which is then used in the corrugated board unit, for example as a lamination web. The printing device works with at least one printing ink.

The design of the first glue application device 21 is described in more detail below with reference to FIGS. 4 to 8.

The first glue application device 21 is embodied as a glue application roller and comprises a hollow-cylindrical elongated main part 72.

Two bearing bodies 73 are arranged on the main part 72. The bearing bodies 73 are preferably identical and arranged in axial end regions of the main part 72. The bearing bodies 73 and the main part 72 are connected to one another for conjoint rotation. Each bearing body 73 carries on the outside a cylindrical bearing pin 74 which forms an axis of rotation of the first glue application roller 21 coinciding with a longitudinal center axis M. The main part 72 is rigid and has an axial width that is at least as wide as the endless first material web 16 or endless first corrugated web.

The first glue application roller 21 also comprises an intermediate body 75, which preferably extends adjacent to an outer peripheral surface 77 of the main part 72, forming an annular gap 76. The intermediate body 75 is annular in cross-section and extends around the longitudinal center axis M. It is, for example, tubular or hollow-cylindrical and made of a yielding or flexible material. It preferably extends (substantially) over the entire axial width of the main part 72. The annular gap 76 is limited radially inwardly by the main part 72 and radially outwardly by the intermediate body 75.

A grid-like opening body 78 is arranged on the outside in relation to the intermediate body 75 and thus forms an outer body. The opening body 78 is annular in cross-section and is preferably in direct connection with the intermediate body 75. It is hollow-cylindrical and extends around the longitudinal center axis M. The intermediate body 75 is thus arranged between the main part 72 and the opening body 78. It preferably extends (substantially) over the entire axial width of the main part 72.

A plurality of continuous openings 79 are formed in the opening body 78, each of which establishes a connection between the intermediate body 75 and the surrounding environment. Each opening 79 is spatially delimited on the circumference and extends radially. The openings 79 are identical. They are preferably arranged (substantially) throughout the opening body 78. They are arranged along its circumference and axial width. Each opening 79 has a radial depth T and a constant opening area in cross-section or in plan view. Furthermore, each opening 79 has a corresponding volume V, which here is a glue-receiving volume or glue-dispensing volume. The intermediate body 75 extends beneath the openings 79 and beyond them.

A plate-like termination part 80 is arranged on the end side of each bearing body 73 and has a corresponding central opening for the respective bearing pin 74 and covers the main part 72 on the end side. Each termination part 80 fastens the intermediate body 75 and opening body 78 in place relative to the adjacent main part 72. It also delimits the annular gap 76 axially. The termination parts 80 extend parallel to each other.

An axially extending feed 81 is arranged centrally in each bearing body 73. Furthermore, a plurality of distribution ducts 82 are arranged in each bearing body 73, which are in flow connection with the respective feed 81 and extend radially outward from this feed 81. The distribution ducts 82 arranged in each bearing body 73 are preferably arranged in one plane and angularly evenly spaced from one another.

In the main part 72, several loading ducts 83 are arranged, which extend radially and completely pass through the main part 72. Each loading duct 83 establishes a flow connection between a distribution duct 82 and the annular gap 76. Each loading duct 83 has a radially inner inlet and a radially outer outlet.

Each feed 81 is in flow connection with a loading device 84, which is, for example, part of the first apparatus 2 for producing a first corrugated board web laminated on one side. For example, a corresponding common loading device 84 is present.

In use, on the outside of the opening body 78, i.e. on its working surface, there is glue from the first glue container 24 and this is applied to the peaks of the corrugation of the endless first material web 16 or corrugated web. The first glue metering device 22, which is designed as a glue metering roller, rests against the outside of the opening body 78 and serves to form a uniform glue layer on the opening body 78. The first glue application roller 21 rotates about its longitudinal center axis M and extends perpendicular to the conveying direction of the endless first material web 16 or corrugated web. The first glue metering roller 22, which extends parallel to the first glue application roller 21, also rotates correspondingly.

When the loading device 84 is not in operation or is only operated at low power, the intermediate body 75 remains undeformed. It seals the openings 79 radially on the inside and extends only outside or below them. In particular, it does not engage in the openings 79 from radially inside. Glue can thus be received over the full liquid-receiving volume V in the respective opening 79 and can also be dispensed again correspondingly to the endless first material web 16.

If, however, the loading device 84 is in operation or is being operated with sufficient power, a pressing force is generated in the annular gap 76 via a loading fluid via the feeds 81, the distribution ducts 82, and the loading ducts 83, which pressing force acts on the intermediate body 75 from radially inside. In particular, the intermediate body 75 experiences a uniform pressure loading from radially inside to radially outside. The intermediate body 75 is moved or pressed radially outwardly in the direction of the opening body 78. Depending on the pressure of the loading fluid, the intermediate body 75 is pressed from radially inside into the openings 79, whereby their liquid-receiving volume V is reduced from radially inside. The intermediate body 75 is curved radially outwardly in the region of each opening 79, for example in a dome-like manner. It lies tightly against the opening body 78 and forms a glue barrier. Loadings of different strengths and corresponding positions of the intermediate body 75 are shown as examples in dashed lines in FIG. 8.

The further the intermediate body 75 engages in the respective opening 79 from radially inside, the less glue can be received there and also dispensed again accordingly. The openings 79 are thus only able to partly receive glue and dispense it again correspondingly. The amount of glue applied or dispensed can be metered in this way. It can be changed during production without stopping it.

If the loading on the intermediate body 75 is reduced again, its engagement with the opening body 78 is also reduced again.

Alternatively or additionally, the first glue metering device 22 is designed similarly to the first glue application device 21 and is thus able to receive or dispense different amounts of glue via its working surface.

The second apparatus 32 for producing a second corrugated board web laminated on one side is preferably equipped with a corresponding glue application device 21 and/or glue metering device 22 in a similar way to the first apparatus 2 for producing a first corrugated board web laminated on one side.

Each feed 81 is in flow connection with a loading device 84, which is, for example, part of the second apparatus 32 for producing a second corrugated board web laminated on one side. For example, a corresponding common loading device 84 is present.

The first gluing application device 63 and/or the second gluing application device 67 are preferably again designed like the first glue application device 21. They are therefore capable of receiving and dispensing different amounts of glue. Each gluing application device 63, 67 is in direct contact with the respective corrugated board web 20 or 48 laminated on one side and applies glue to its corrugation or fluting from below.

Alternatively or additionally, the first glue squeezing device 64 and/or second glue squeezing device 68 are designed like the first glue application device 21 and are thus capable of receiving and dispensing glue in different quantities. They are located on the outside of the first and second gluing application devices 63, 67.

Each feed 81 is in flow connection with a loading device 84, which is, for example, part of the gluing unit 61. For example, a corresponding common loading device 84 is present.

Alternatively, the endless corrugated board web 1 laminated on both sides is, for example, three-ply or seven-ply.

It is expedient if at least one printing roller or metering roller in the printing device is designed similarly to the first glue application device 21 and is thus able to receive and dispense different amounts of printing ink. The printing device is formed in particular as a screen printing device or flexographic printing device.

The terms “downstream”, “upstream”, “before”, “after” or the like as used herein refer in particular to the conveying of the web(s).

1. A liquid device comprising:
a) a main part,
b) comprising an intermediate body which is arranged above the main part, and
c) comprising an opening body which is arranged above the intermediate body and which has openings,
wherein the intermediate body and/or the opening body can be loaded and the intermediate body can be designed such that the intermediate body is capable of changing a liquid-receiving volume of at least one of the openings, in particular of at least a plurality of the openings, by at least partly engaging in same.

2. The liquid device according to claim 1, wherein the liquid device is designed as a liquid metering device, liquid squeezing device, liquid application device, liquid transfer device, gluing device, pre-coating device and/or inking device.

3. The liquid device according to claim 1, wherein the openings are each continuous.

4. The liquid device according to claim 1, wherein the openings are arranged in a region of the opening body which makes up at least 60% of the opening body.

5. The liquid device according to claim 1, wherein the opening body is designed as a grid body or screen body.

6. The liquid device according to claim 1, wherein characterized in that the openings are each square in a plan view.

7. The liquid device according to claim 1, wherein the intermediate body and/or opening body can be loaded in such a way that the intermediate body is capable of reducing the liquid-receiving volume of the at least one of the openings by at least 5%.

8. The liquid device according to claim 1, wherein the intermediate body and/or opening body can be loaded in a spatially limited manner, wherein preferably the spatial limitation is variable.

9. The liquid device according to claim 1, wherein the main part is designed as a roller, wherein the intermediate body is annular in cross-section and the opening body is annular in cross-section.

10. The liquid device according to claim 9, wherein at least one loading duct for loading the intermediate body is arranged in the main part.

11. The liquid device according to claim 1, wherein the main part is plate-shaped.

12. A liquid apparatus comprising:
a) at least one liquid device according to claim 1, and
b) at least one loading device which is at least temporarily connected to the at least one liquid device for loading the intermediate body and/or opening body.

13. The liquid apparatus according to claim 12, wherein the at least one loading device is of hydraulic, pneumatic and/or mechanical type.

14. A system comprising:
a) at least one liquid apparatus according to claim 12, and
b) a corrugated board unit comprising
i. at least one apparatus for producing at least one corrugated board web laminated on one side,
ii. an apparatus for producing a corrugated board web laminated on two sides, comprising at least one corrugated board web laminated on one side, and
iii. a gluing unit arranged between the at least one apparatus for producing at least one corrugated board web laminated on one side and the apparatus for producing a corrugated board web laminated on two sides, for applying glue to the at least one corrugated board web laminated on one side,
wherein the at least one liquid apparatus is part of the corrugated board unit or is arranged upstream thereof.

15. The system according to claim 14, wherein the at least one liquid device is part of the at least one apparatus for producing at least one corrugated board web laminated on one side of the gluing unit, a printing device and/or a pre-coating device.
